(19) United States
(12) Patent Application Publication
(10) Pub. No.: US 2013/0276823 A1
(43) Pub. Date: Oct. 24, 2013

(54) Hyperbaric CNX for Post-Wafer-Saw Integrated Clean, De-Glue, and Dry Apparatus & Process

(71) Applicant: ADVANCED WET TECHNOLOGIES GMBH, Huefingen (DE)

(72) Inventor: Richard W. Plavidal, Milpitas, CA (US)

(73) Assignee: Advanced Wet Technologies GmbH, Huefingen (DE)

(21) Appl. No.: 13/869,036

(22) Filed: Apr. 24, 2013

Related U.S. Application Data
(60) Provisional application No. 61/637,332, filed on Apr. 24, 2012.

(51) Int. Cl. B08B 3/10

(52) U.S. Cl. CPC B08B 3/10
USPC 134/3; 134/30; 134/25.4; 134/201; 134/95.2; 134/2

(57) ABSTRACT

Silicon plates can be cleaned, rinsed and dried by hyperbaric superheated liquid and superheated steam. The superheated liquid can be used to clean and rinse the silicon plates after being saw from a silicon block. A slow drain can be open to remove the superheated liquid. A fast drain then can be open, preferably to atmosphere, to allow steam to vent through bottom. The fast drain can function as a drying process, vaporizing water droplets down the drain with the escaping steam.

This application claims priority from U.S. provisional patent application serial no. 61/637,332, filed on Apr. 24, 2012, entitled “Hyperbaric CNX for Post-Wafer-Saw Integrated Clean, De-Glue, and Dry Apparatus & Process”, which is incorporated herein by reference.

### BACKGROUND

Parts or devices with complex shapes pose a special challenge for cleaning due to small openings, internal dead spaces, blind holes and other hard to access places within the part. Traditional sprays and sonic agitation cannot access these areas effectively and even if they could it would be difficult or impossible to remove loosened debris and contaminated cleaning solutions from these parts. Even complex manifold flow connections cannot effectively flush contamination from trapped areas and dead spaces within some parts.

Silicon wafers are typically fabricated from a brick (e.g., for square silicon wafers for solar cell applications) or an ingot (e.g., for circular silicon wafers for semiconductor and solar cell applications) of silicon that is glued to a sacrificial plate. The silicon brick and the plate are then placed in a wire saw that simultaneously cuts completely through the silicon brick and partially into the sacrificial plate. This forms a wafer plate that comprises the individual wafers attached to the plate at a side edge of the wafer by the glue. After complete sawing, the wafers are covered with a sludge, which comprises cut silicon, together with wet slurry and abrasive compound used in the sawing process. The wafer plate and sludge is removed from the wire saw and then goes through a series of equipment and process steps to pre-clean the wafers of sludge, de-glue the wafers from the plate and then carefully separate the wafers while still wet and place them into wafer cassettes for further processing. This process currently involves multiple pieces of equipment, is expensive, and results in significant wafer breakage, especially during the wet wafer separation step. This is because the fragile wafers are held together by sticking force of water.

### SUMMARY

In some embodiments, methods and apparatuses are provided for cleaning, rinsing and drying wafers after being saw using hyperbaric pressure liquid or gas. Superior cleaning, rinsing and drying can be achieved in a suitably configured hyperbaric chamber system using saturated or superheated steam or water. In addition, chemicals can be added to improve the cleaning process.

In some embodiments, a cleaning, rinsing and drying process can include loading post-wafer-saw blocks into a hyperbaric chamber. The chamber can be pre-filled and purged with steam superheated steam or nitrogen to remove air that could oxidize silicon. Afterward, the chamber is filled to full pressure with steam from a supply reservoir. The superheated water is then introduced in shower mode to rinse and continue heating silicon object. After the chamber and the silicon reach a desired temperature, a slow drain is open to remove excess water. When the liquid drainage is complete, a fast drain is open, preferably to atmosphere, to allow steam to vent through bottom. The drying process can comprise vaporization of water droplets and/or direct displacement of trapped water, e.g., in droplet forms, down the drain with the escaping steam.

### BRIEF DESCRIPTION OF THE DRAWINGS

FIG. 1A illustrates an exemplary silicon brick or ingot attached to a plate according to some embodiments.

FIG. 1B illustrates an exemplary wafer plate comprising cut silicon wafers attached to a plate according to some embodiments.

FIGS. 2A-2C illustrate exemplary carriers supporting a wafer plate according to some embodiments.

FIGS. 3A-3G illustrate an exemplary sequence of cleaning and drying wafers according to some embodiments.

FIG. 4 illustrates an exemplary system configuration for a hyperbaric process according to some embodiments.

FIG. 5 illustrates a flow chart for a cleaning process according to some embodiments.

FIG. 6 illustrates another flow chart for a cleaning process according to some embodiments.

FIG. 7 illustrates an exemplary flow chart for a hyperbaric process for cleaning, rinsing and drying wafers according to some embodiments.

### DETAILED DESCRIPTION OF THE EMBODIMENTS

The development of CNX (Cycle Nucleation Transport) Technology represented a breakthrough in addressing the aforementioned problem. With CNX it was possible to grow and collapse vapor bubbles which would displace fluids and dislodge contamination from hidden surfaces independent of boundary layers and geometries which would otherwise block any cleaning agitation or displacement. A key attribute of CNX is that all surfaces see the same pressure in a pressure controlled environment. Therefore, vapor bubbles will be created at any surface, whether hidden from direct view or not. As long as the pressure is held below the fluid vapor pressure, nucleation continues unabated and displacement currents continue to flow. Upon re-pressurization the vapor bubbles collapse and bring both fresh fluid and kinetic energy to the surface.

In some embodiments, methods and apparatuses of an integrated hyperbaric CNX process that can pre-clean, de-glue, and dry the wafers in one piece of equipment. Dried wafers can be easily handled and separated for subsequent processing.

In some embodiments, the present invention discloses methods and apparatuses of hyperbaric CNX for pre-clean, de-glue, and dry wafers from wafer plates after sawing. Simplified processes of cleaning, separating and drying of silicon wafers can be achieved in a suitably configured H-CNX (hyperbaric CNX) system using saturated or superheated steam or water. Superior rinsing and drying can be achieved in a suitably configured H-CNX (hyperbaric CNX) system using saturated or superheated steam or water. In addition, chemicals can be added to improve results or to add cleaning steps prior to the final rinse and drying steps.

In some embodiments, the present hyperbaric CNX can clean and remove sludge from between wafers without aggressive conventional methods using brushes and high pressure sprays. The CNX action actually pushes out sludge from between wafers with each pressure cycle.

Then, after de-gluing, the wafers are dried using hyperbaric CNX Rapid Displacement Drying where water is displaced and removed from between wafers by flashing steam and then complete drying is accomplished by excess heat in remaining superheated water and hot silicon wafers to rapidly evaporate as wafers and steam are brought back to atmosphere.

Saturated steam is steam that is in equilibrium with heated water (e.g., saturated water) at the same pressure. For example, at atmospheric pressure, water is boiled at 100 C, generating saturated steam and saturated water. If saturated steam is reduced in temperature while keeping the same pressure, it will condense to produce water droplets. For example, a saturated water contains as much thermal energy as it can without boiling. Conversely a saturated vapor contains as little thermal energy as it can without condensing.

Superheated steam is steam at a temperature higher than water's boiling point. If saturated steam is heated at constant pressure, its temperature will also remain constant as the steam becomes dry saturated steam. Continued heating will then generate superheated steam.

Superheated water is liquid water under pressure at temperatures between the usual boiling point (100° C.) and the critical temperature (374° C.). It is also known as subcritical water and pressurized hot water. Superheated water can be stable under high pressure, for example, by heating in a sealed vessel with a headspace, where the liquid water is in equilibrium with water vapor at the saturated vapor pressure. This is different with unstable superheating, which refers to water at atmospheric pressure above its normal boiling point and which has not boiled due to a lack of nucleation sites.

In some embodiments, the hyperbaric chamber and supply reservoir can operate, for example, at up to 16 bar and up to 200 C. For example, very high specific heat of water, 6 times greater than silicon, can be used to quickly and efficiently heat wet silicon object using superheated/saturated water. The water can then be drained under pressure leaving hot parts and residual trapped superheated water in a saturated steam environment. The wetted wafers can then be dried through an evaporation and rapid displacement drying process using heated steam.

In some embodiments, the sludge, e.g., silicon particles and residues from a silicon sawing process, can be removed together with the steam and water down and out of the chamber when the drain valve is opened. The small particulates and residues will concentrate at the bottom of the cleaning tank, which can be jetted away when the drain valve is opened, for example, due to the difference in pressure between the process chamber and the outside ambient. The liquid can be flashing to vapor as pressure is released and causing excess liquid to be jetted away (a.k.a. rapid displacement drying).

Since the smaller particles will concentrate at the bottom, escaping steam velocity increases at the bottom of the carrier to jet away excess retained water where the extra velocity is required. The liquid can be flashing to vapor as pressure is released and causing excess liquid to be jetted away. This process of using vapor to displace liquid from object surfaces is called Rapid Displacement Drying.

In some embodiments, remaining trapped water on the plates will be flashed to steam as the pressure reaches 1 bar due to the remaining heat in both the superheated water as well as the excess heat from the silicon as it cools to 100\textcircled{P}C.

Optionally, inert gas such as nitrogen gas can be introduced into the chamber to prevent any air from oxidizing the silicon and also to assist with cool down and remove any remaining moisture. In the context of the present invention, an inert gas includes a gas that does not react with the silicon object, e.g., does not oxidize the silicon. Thus an inert gas can include non-oxygen containing gas, such as nitrogen, or hydrogen.

In some embodiments, a cleaning and drying process comprises loading a wafer plate, e.g. the cut wafers glued to a plate, into a carrier. The carrier can be specifically designed to support the wafer plate, especially in event that the wafers are separated from the plate. For example, the carrier can comprise two side bar supports, holding the wafers at two opposite sides, for example, with multiple slots. Alternatively, the carrier can comprise a wafer boat, supporting the wafers at opposite side of the plate. The carrier supporting the wafer plate is then placed into a hyperbaric CNX chamber. The chamber can be pre-rinsed to remove excess sludge from the wafers and wafer plate. The pre-rinsing process can comprise spraying with warm water. The drainage can be opened to remove the sludge from the chamber.

The chamber can then be pre-filled and purged with steam (saturated or superheated) to remove air that could oxidize silicon. Afterward, the chamber is filled to full pressure, for example, with steam (saturated or superheated) from a supply reservoir. The water (saturated or superheated) is then introduced, for example, in shower mode or simply in flowing mode, to submerge and continue heating the wafer plate. In some embodiments, the heat will cause the glue to release the wafers from the plate. The wafers can then be supported by the carrier, and the plate can be put aside or removed. In some embodiments, the water is drained, for example, as the water flowing in shower mode, or after a certain level of water to submerge the silicon plates. After the chamber and the silicon reach a desired temperature, a slow drain is open to remove excess water. When water is completely drained, e.g., the water level is zero, a fast drain is open, preferably to atmosphere, to allow steam to vent through bottom. Steam (superheated or saturated, and preferably superheated to avoid wetting silicon) can be re-introduced to re-pressurize the chamber. The fast drain can again be open to further dry the silicon. The drying process can comprise vaporization of water droplets and/or direct displacement of trapped water, e.g., in droplet forms, down the drain with the escaping steam. Again, this drying method is called Rapid Displacement Drying (RDD). The RDD process can repeat as necessary to displace as much trapped water as possible.

Optionally, dry nitrogen can be introduced to purge chamber of steam, continue removing moisture, and cooling down to acceptable level before exposure to atmosphere.

In some embodiments, the present invention will be applied to similar cleaning, rinsing, and drying applications, such as wafers saw from a single crystal wafer ingot, wafers saw from a polycrystalline silicon block, or wafers saw from a semiconductor block, such as silicon-containing blocks or compound semiconductor blocks. The materials being processed may vary but the specific technical challenges remain identical. Furthermore, the apparatus configuration and process sequences will be similar.

In some embodiments, the cyclic nucleation process is performed at hyperbaric pressure to clean the wafers. For example, a steam vent can be cyclically open and close to produce CNX cleaning When the steam valve is open, for example, to atmospheric pressure, the pressure in the process chamber is reduced, generating bubbles at the wafer surfaces. When the steam valve is close, the pressure increases, terminating the bubbles and remove the sludge from the wafer surfaces. The water can be drained to remove the sludge that are removed from the wafers and collected at the bottom of the chamber. In some embodiments, the water is drained to a pressurized waste container, to avoiding losing pressure in the chamber. For example, the pressure of the waste container can be similar or slightly less than the pressure of the process chamber, thus the water can be drained without losing any pressure. In some embodiments, the pressure of the waste container can be optimized to also generate a strong drain flow from the process chamber, pushing sludge out of the process chamber. In some embodiments saturated steam will be simultaneously introduced during drainage to maintain pressure and temperature and assist drainage.

In some embodiments, the cyclic pressure (CNX process) and water drainage can be repeated until the wafers are cleaned. Different solutions and chemical mixtures can be used for cleaning, for example, solvent, detergent surfactant, and etching chemicals can be used or mixed in solution during the cleaning process.

The water is then completely drained to remove all excess water. When water is completely drained, steam can be back filled to maintain temperature and pressure. The steam can be released through vent valve to drop pressure. Flashing steam between wafers will displace much of the superheated water trapped between wafers; this is Rapid Displacement Drying with CNX. Remaining trapped water will be flashed to steam by excess heat in both superheated water and the silicon wafers as the system cools to 100 C and 1 bar. Nitrogen purge can then be introduced to remove moisture, prevent oxidation of silicon, and cool down the carrier and parts. The carrier can be unloaded from the Hyperbaric CNX chamber. The clean and dry wafers are removed from the carrier, ready for further processing.

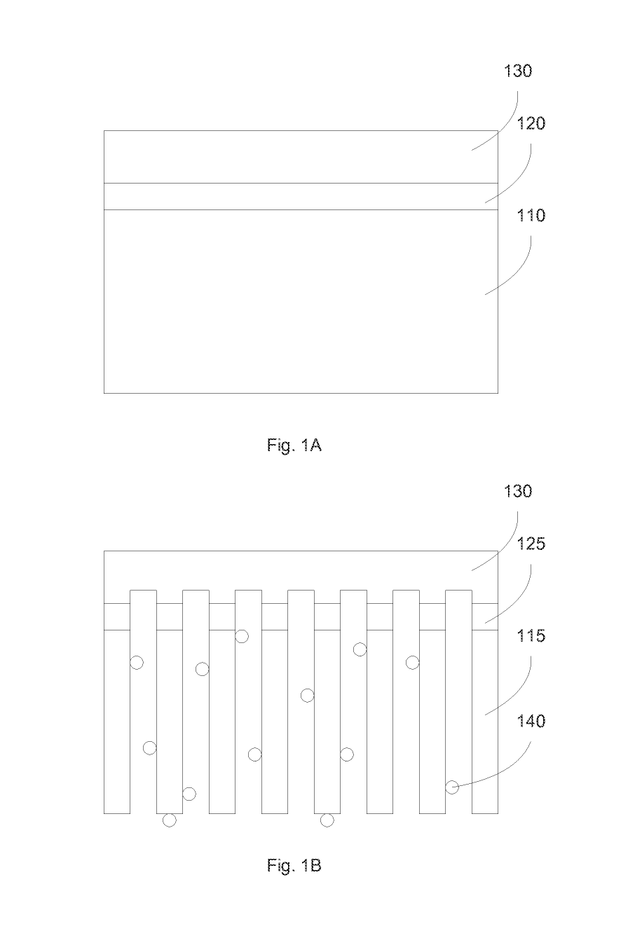

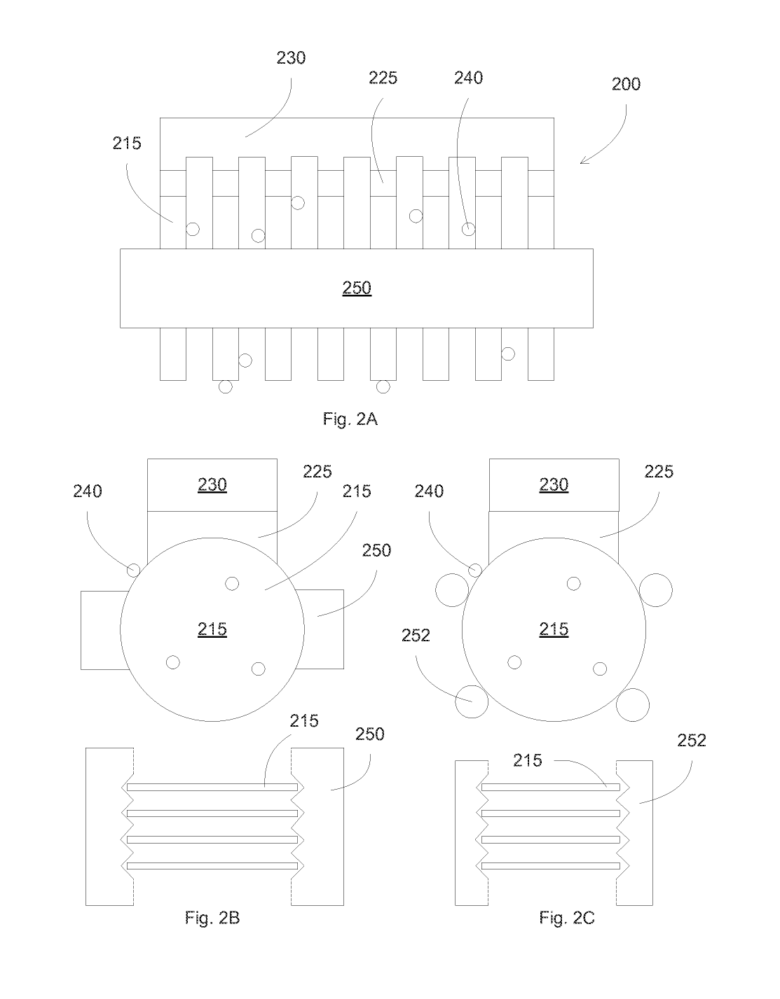

FIG. 1A illustrates an exemplary silicon brick or ingot attached to a plate according to some embodiments. The silicon brick or ingot 110 is attached to a plate 130 by a glue layer 120.

FIG. 1B illustrates an exemplary wafer plate comprising cut silicon wafers attached to a plate according to some embodiments. The silicon brick or ingot, e.g., single crystal silicon for semiconductor applications or polycrystalline silicon for solar applications, is wire sawn into wafers 115, which are still attached to the plate 130 through a layer of glue 125. The wire saw typically cuts through the glue layer and into the plate. Residues 140, such as silicon dust or abrasive slurry used in facilitating the sawing process, form a sludge covering much of the wafers.

FIGS. 2A-2C illustrate exemplary carriers supporting a wafer plate according to some embodiments. FIG. 2A shows a side view and FIG. 2B shows a front view of a carrier supporting a wafer plate 200. The wafer plate 200 comprises individual cut wafers 215 attached to a plate 320 through glue 225. Sludge 240 covers the surface of the wafer plate. A carrier 250 supports the wafers at two opposite sides. The carrier is designed to hold the wafers even when the glue is released.

FIG. 2C shows another exemplary carrier comprising four bars 252 running along the side of the wafers. The bars 252 are configured to support the wafers, with or without the glue layer. In some embodiments, the bars have notches or slots to engage the edges of the wafers.

In some embodiments, the present invention discloses methods and apparatuses for cleaning, and drying wafers in a wafer plate using hyperbaric pressure. Hyperbaric pressure process can significantly simplify the cleaning, and drying equipment, for example, by eliminating vacuum pumps or power during the cyclic process. In addition, hyperbaric pressure processes can extend the temperature range, which can lead to faster reaction rates, increasing processing speed and cleaning effectiveness. Further, the consumables can be less expensive and more environment friendly, for example, water and steam at elevated temperatures can be used instead of highly reactive chemicals.

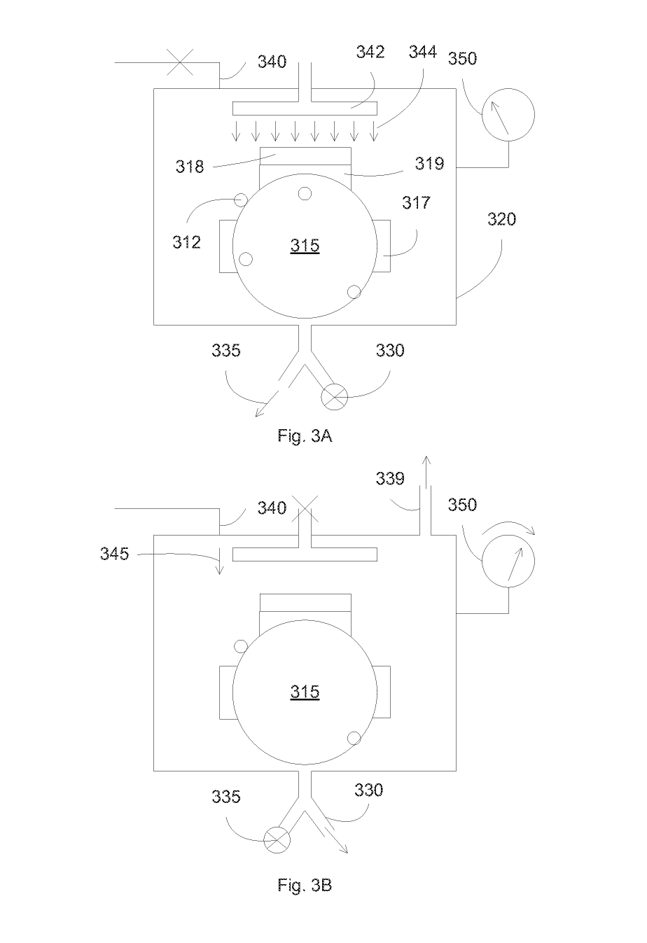

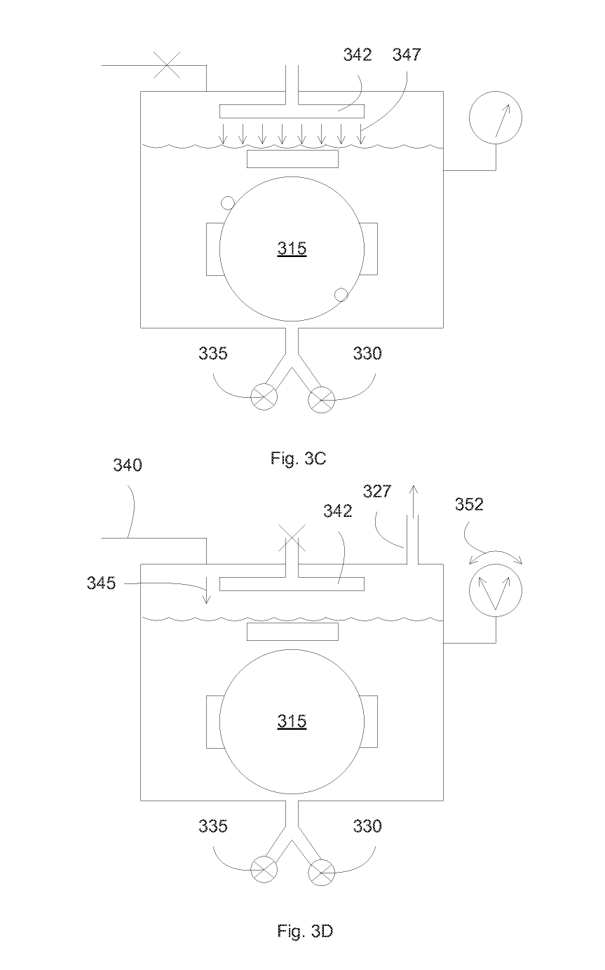

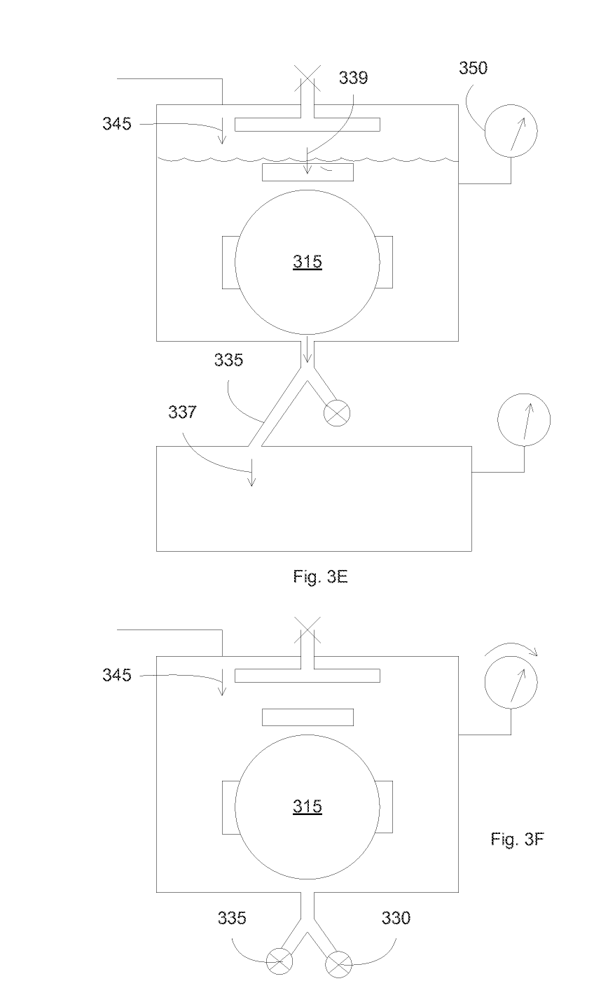

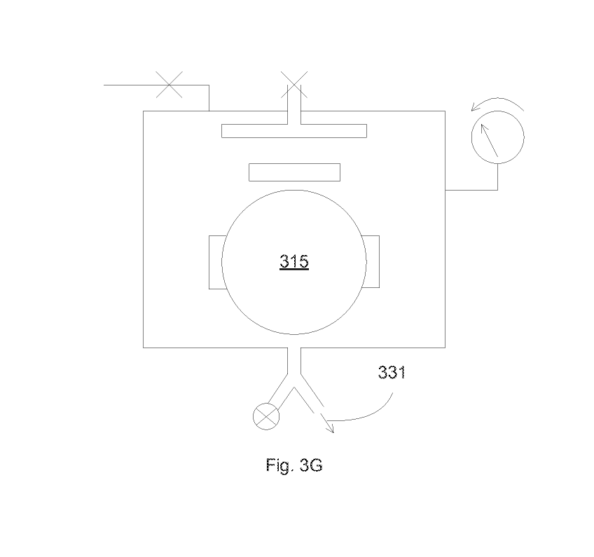

FIGS. 3A-3G illustrate an exemplary sequence of cleaning and drying wafers according to some embodiments. In FIG. 3A, the wafer plate, e.g., the cut wafers 315 attached to the plate 318 through thin glue 319 along the edge of each wafer is loaded to a carrier 317 which is designed to support the wafers even if the glue layer is released. The wafer plate is covered with sludge 312, which typically comprises silicon dust generated from the sawing process, and lubricant and abrasive particles to assist the sawing process. The wafer plate is loaded to a hyperbaric chamber 320. A pre-rinse can be performed to clean the sludge from the wafer plate. For example, warm water 344 can be used by spraying or showering from a showerhead 342 toward the wafer plate. A drain 335 is open to drain the sludge that has been removed from the wafer plate. The pressure in the chamber can be at atmospheric pressure, as indicated by a pressure gauge 350. The chamber can comprise other inlets and outlets, such as inlet 340 for steam or gas delivery and outlet 330 for steam release.

In FIG. 3B, the pre-rinsing process stops, for example, turning off the water flow 344 and draining excess water in the chamber. The drain valve 335 is also closed. Steam 345 may then be delivered to the chamber through inlet 340 to purge air out of the chamber, and to bring chamber up to the operating pressure, which is a hyperbaric pressure above the atmospheric pressure. For example, a steam vent valve can be opened at an outlet 339 to release excess steam in the chamber. A drain valve, e.g., 330, can also be open during the beginning of the steam 345 to remove air out of the chamber. After a certain time, valves 330 and 339 can be closed, and the chamber pressure increases.

In FIG. 3C, after the chamber is purged of air and is at least partially pre-heated and pre-pressurized, hot liquid, such as superheated or saturated water, is introduced to the chamber to submerge the wafer plate. For example, the hot liquid 347 can be provided by the showerhead 342. Alternatively, another inlet can be used to deliver the hot liquid 347. Since the wafer plate is submerged in the hot liquid, the glue might be dissolved, releasing the plate from the wafers. The wafers are now supported and separated by the carrier. In some embodiments, the plate 318 is de-bonded from the wafers 315 during the supplying of the superheated liquid, and before the hyperbaric CNX cleaning process.

In FIG. 3D, hyperbaric cyclic nucleation process is performed to clean the sludge from the wafers. For example, the pressure 352 can oscillate between high and low pressures, terminating and generating bubbles to clean away sludge. The pressure can be dropped by opening a pressure release valve, for example, at an outlet 327. This drop in pressure generates bubble formation. The bubbles can be terminated and collapsed by closing the valve outlet 327 and waiting for pressure to re-stabilize. Alternatively, the pressure cycling process can be actively performed by adding superheated or saturated steam to the chamber. For example, pressure can be more rapidly increased by opening the steam inlet 340 and allowing saturated or superheated steam or vapor to enter the chamber. Pressure can be released by opening the valve outlet 327.

In FIG. 3E, the cleaning is stopped and the drain valve 335 is opened to remove the sludge. For example, the cyclic cleaning can be stopped after a number of cleaning cycles. The cyclic cleaning can be stopped when the water is full of sludge released from the wafers. The cyclic cleaning can be stopped when the cleaning is no longer effective due to excess sludge in the water. In some embodiments, the valve 335 is opened to a waste container, flowing sludge 337 to the container. The container may be under pressure to prevent much loss of pressure in the process chamber. For example, the container can have pressure equal or slightly less than the pressure of the chamber. In some embodiments, to improve the waste flow, e.g., to force the sludge to be drained to the waste container, steam 345 can be introduced to increase the pressure in the chamber.

The chamber can be re-filled with hot liquid, and the cyclic nucleation process can resume, continuing to clean the wafers. In addition, different liquid can be used, such as solvent or etchant to etch the wafer, or cleaning chemicals to clean the wafers. After the wafers are cleaned, the liquid is removed from the process chamber. The chamber can be back filled with steam to maintain temperature and pressure (FIG. 3F).

In FIG. 3G, drain valve is open, for example, to atmosphere, to release steam 331 from the chamber. The rapid drop in pressure can vaporize any liquid droplets on the wafer surfaces, drying the wafers. The vaporized liquid also acts to displace remaining water droplets as the vapor expand rapidly—thus assisting in the drying process. In some embodiments, superheated steam, i.e., dry steam, is used to fill the process chamber. Superheated steam is dry, and thus does not re-wet the wafers during the drying process. For example, the drying sequence can comprise filling the process chamber, containing wet wafers, with superheated steam to a high pressure (above atmospheric pressure). Then the steam is quickly released, vaporizing liquid on the wafer surface to dry the wafers. This method of drying is called Rapid Displacement Drying.

Optional nitrogen purge can be performed to remove moisture, prevent oxidation of silicon, and cool down the carrier and parts. The wafers are removed from the chambers.

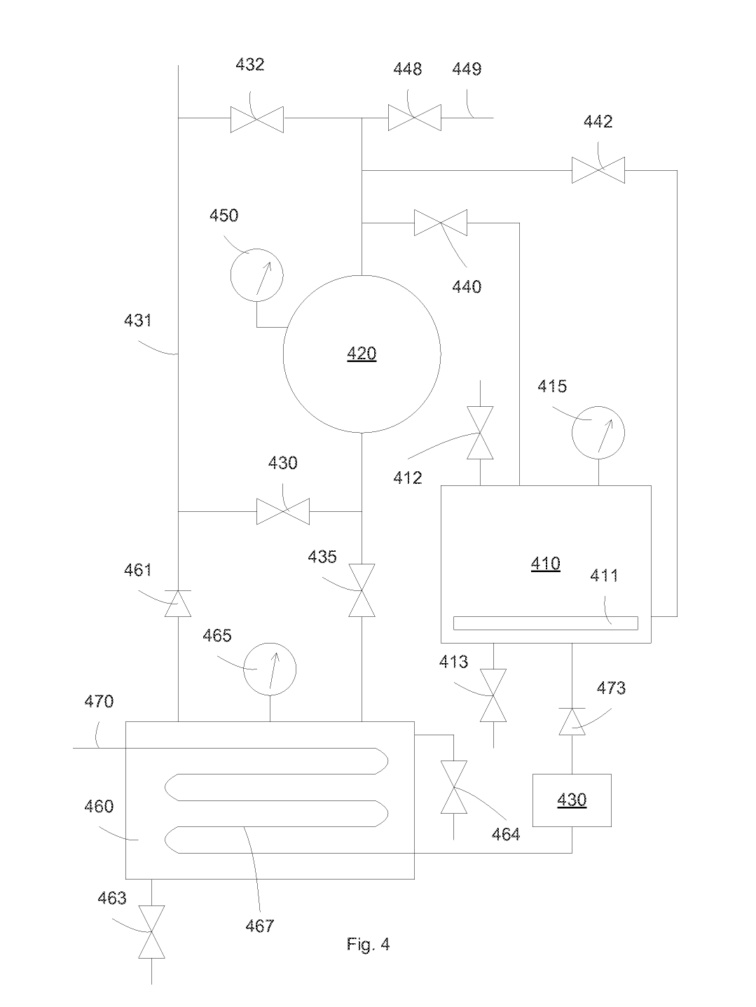

FIG. 4 illustrates an exemplary system configuration for a hyperbaric process according to some embodiments. A process chamber 420 can be used to clean, rinse and dry wafers. The process chamber can comprise a pressure gauge 450 to monitor the chamber pressure. The process chamber can comprise a plurality of inlets, coupled to valves for controlling the inlet flows. A gas inlet is controlled by gas valve 440, for example, to deliver saturated or superheated vapor such as steam to the process chamber. A liquid inlet is controlled by a liquid valve 442, for example, to deliver saturated or superheated liquid such as heated water to the process chamber. Another gas inlet is controlled by valve 448, for example, to deliver inert gas such as nitrogen 449 to the process chamber.

The process chamber can comprise outlet, such as a drainage, which can be controlled by valve 430 and 435 to provide different draining from the process chamber. For example, control valve 430 is coupled to vent line 431, operable to exhaust vapor from the process chamber to atmosphere. Valve 430 is used for the Rapid Displacement Drying process. Control valve 435 is coupled to a container 460, which is preferable under pressure (monitored by pressure gauge 465), which is similar or slightly lower than the pressure of the process chamber. The container 460 can be operable to collect liquid, draining from the process chamber.

A reservoir 410 can be included to supply saturated or superheated liquid and/or vapor to the process chamber. The reservoir 410 can comprise a heater 411 to heat the liquid in the reservoir, preferably to a temperature and pressure above the boiling temperature and above atmospheric pressure. A pressure gauge 415 can be included to monitor the pressure of the reservoir. The reservoir should be equipped with a pressure relief valve 412 for safety and a drain valve 413. Heated liquid, e.g., saturated liquid or superheated liquid, can be delivered to the process chamber through control valve 442. Heated vapor, e.g., saturated vapor or superheated vapor can be delivered to the process chamber through control valve 440.

The CNX process is performed by cycling valve 432 open and shut. The resulting pressure drop when valve 432 is open will cause immediate bubble generation. Shutting valve 432 will allow the pressure to rise and re-stabilize, collapsing vapor bubbles. Alternatively, after shutting valve 432, saturated or superheated vapor from the reservoir 410 may be introduced into the chamber by opening valve 440. This sudden rise in pressure will immediately collapse bubbles in the chamber 420.

The container 460 can comprise an optional heat exchanger 467, which can be operable to heat fresh liquid 470, for example to supply to the reservoir 410, through liquid pump 430 and check valve 473. The heat exchanger 467 can recycle wasted heat from the process chamber, utilizing the wasted heat from the drained liquid to heat fresh liquid. The container can comprise a number of outlets, for example, a dirty drain valve 463 coupled to a bottom of the container to drain any debris collected from the process chamber. Another drain valve 464 is coupled to a top portion of the container to prevent overflow of the container. An exhaust line coupled to a check valve 461 can be used to exhaust vapor to a vent line 431.

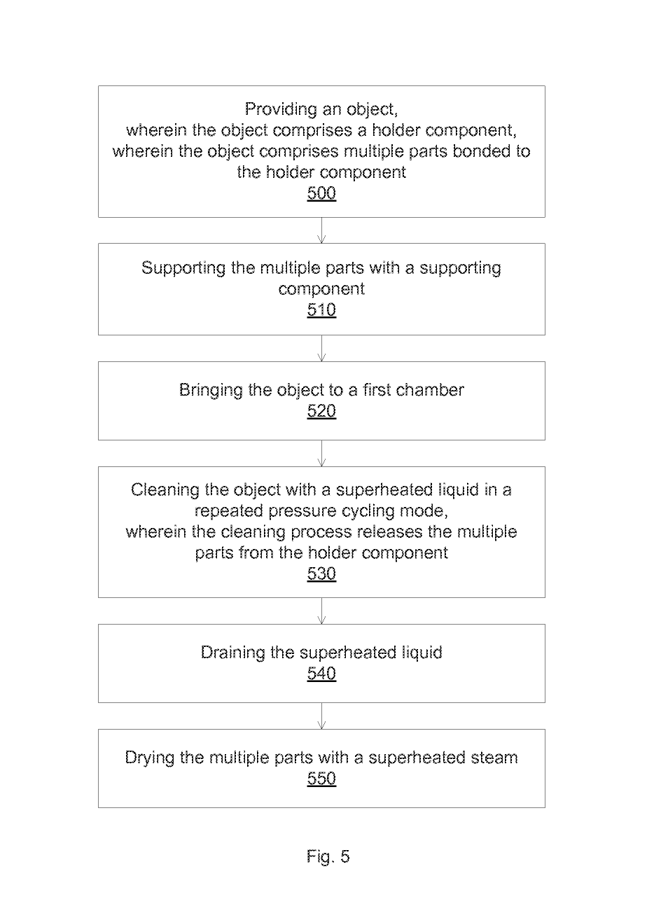

FIG. 5 illustrates a flow chart for a cleaning process according to some embodiments. Operation 500 provides an object. The object can include a holder component together with multiple parts attached, e.g., bonded by a glue layer, to the holder component. For example, the object can include a block of silicon, either single crystal or polycrystalline block of silicon. The block of silicon can be glued to a holder component, such as a holder plate, at a portion of the edge of the silicon block. Afterward, the silicon block can be saw into multiple parts, such as multiple thin wafers.

For example, the silicon block can have a cuboid shape with two opposite square end faces and four rectangular side faces. A holder plate can be glued to a rectangular side face. The cuboid block can be saw along directions parallel to the end faces, forming multiple square wafers, e.g., plates, that are attached to the holder plate by a thin glue line along one edge of the thin wafers.

The silicon block can have a cylinder shape with two opposite circular end faces. A holder plate can be glued to a portion of the circular side. The cylindrical block can be saw along directions parallel to the end faces, forming multiple round wafers, e.g., plates, that are attached to the holder plate by a thin glue line along a portion of the circular edge of the thin wafers.

Operation 510 supports the multiple parts with a support component. For example, in the cases of cuboid block or cylindrical block, two support plates with slots can be positioned at two opposite sides of the wafers, with the wafers supported and separated by the slots.

Operation 520 brings the object into a chamber. For example, the support component can be secured in the chamber. In some embodiments, the chamber can be sealed and then brought up to a high pressure, e.g., above atmospheric pressure, after the object is loaded into the chamber. The high pressure can be similar to the pressure of a superheated liquid that will be introduced to the chamber for cleaning The high pressure condition can be established by a gas, such as an inert gas that does not oxidize the silicon. Alternatively, a superheated steam can be supplied to the chamber. The superheated steam can be generated together with the superheated liquid, and thus can have the same pressure.

In some embodiments, the object can be etched to remove any native oxide on the silicon surface. For example, a silicon oxide etch chemical, such as HF, can be introduced, together with the high pressure ambient, to clean the surface oxide from the wafers. HF-containing vapor can be added to the superheated steam, so that the silicon wafers can be exposed to an HF environment to remove the native oxide before cleaning

In some embodiments, an oxygen inactive ambient, e.g., an ambient not containing oxygen or an ambient containing oxygen gettering materials, can be established in the chamber, for example to prevent oxidation of the silicon wafers, especially after the native oxide has been removed, for example, after an HF exposure. Inert gas can be introduced to the chamber, or an oxygen gettering chemical can be introduced with the superheated steam.

Operation 530 cleans the object with a superheated liquid in a repeated pressure cycling mode. The temperature of the superheated liquid can be between 100 and 200 C. The pressure of the superheated liquid can be between 1 bar and 16 bar.

In some embodiments, the superheated liquid can release the multiple parts, e.g., wafers, from the holder component. For example, the hot liquid can de-glue the glue layer that attaches the multiple parts to the holder component, thus releasing the holder component. In some embodiments, the holder component can be set aside, for example, dropping to the chamber floor. The object can be loaded with the holder component positioned at a bottom, so a de-glued process can release the holder component so that the holder component can free fall to the chamber floor.

The repeated pressure cycling mode can include supplies a superheated liquid to the first chamber to at least partially submerge the object. The superheated liquid can be partially drained during the supplying, as to provide an initial cleaning of the object. After an initial cleaning, the object can be submerged in the superheated liquid. A cyclic nucleation process can be performed to clean the object, especially in hard to get areas. Since the chamber pressure is above atmospheric, a chamber valve can be open to release the chamber pressure, thus generating bubbles in the liquid for cleaning The valve can be close, and the pressure can be built up to terminate the bubbles. The valve can be cyclically open and close, which can cyclically releasing and stop releasing pressure in the chamber.

In some embodiments, the repeated pressure cycling mode can include repeatedly reducing and stopping reducing the first chamber pressure. For example, a relief valve can be open to reduce the chamber pressure. The relief valve can be close to stop the pressure reduction, with the pressure gradually built up due to the superheated liquid.

In some embodiments, the repeated pressure cycling mode can include repeatedly reducing and increasing the first chamber pressure. For example, a relief valve can be open to reduce the chamber pressure. The relief valve can be close, and a supply valve can be open. The supply valve can deliver superheated or saturated steam to the chamber to increase the chamber pressure.

Operation 540 drains the superheated liquid to a second chamber, wherein the pressure of the second chamber is similar to that of the first chamber when draining For example, the second chamber can have similar pressure, and thus the connection between the first and second chambers can be performed without significantly changing the pressure in the first chamber. In some embodiments, the process can be repeated, e.g., a new superheated liquid can be repeatedly supplied and drained from the chamber, for example, to clean the object to a desired cleanliness.

Operation 550 dries the object, e.g., at least the multiple parts, with a superheated steam. The drying process can include rapidly reducing the pressure in the first chamber to evaporate liquids on the object. For example, after the superheated liquid is drained, the chamber can contain superheated steam. A rapid release of the superheated steam can carry liquid droplets on the object, thus can effectively dry the object. In some embodiments, the process can be repeated, e.g., a new superheated steam can be re-supplied to the chamber, and then re-released for further drying. The new superheated steam can be dry superheated steam. The superheated steam can be released to the atmospheric ambient.

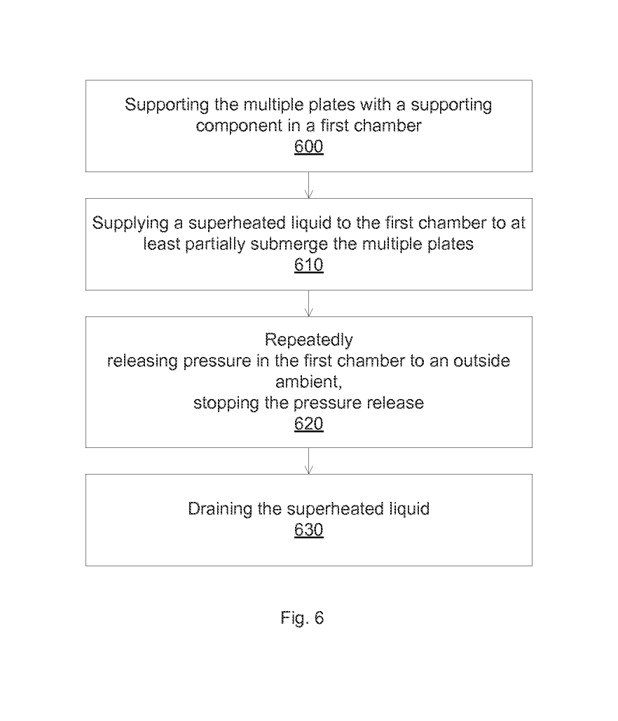

FIG. 6 illustrates another flow chart for a cleaning process according to some embodiments. Operation 600 supports the multiple plates, e.g., wafers, of an object in a chamber by a support component. The multiple plates can be bonded to a holder component. Operation 610 supplies a superheated liquid to the chamber to submerge at least a portion of the object.

In some embodiments, the chamber can be sealed and then brought up to a high pressure, e.g., above atmospheric pressure, before submerging the object. The high pressure can be similar to the pressure of a superheated liquid that will be introduced to the chamber for cleaning. The high pressure condition can be established by a gas, such as an inert gas that does not oxidize the silicon. Alternatively, a superheated steam can be supplied to the chamber. The superheated steam can be generated together with the superheated liquid, and thus can have the same pressure.

In some embodiments, the object can be etched to remove any native oxide on the surface. For example, a silicon oxide etch chemical, such as HF, can be introduced, together with the high pressure ambient, to clean the surface oxide from the wafers. HF-containing vapor can be added to the superheated steam, so that the wafers can be exposed to an HF environment to remove the native oxide before cleaning.

In some embodiments, an oxygen inactive ambient, e.g., an ambient not containing oxygen or an ambient containing oxygen gettering materials, can be established in the chamber, for example to prevent oxidation of the wafers, especially after the native oxide has been removed, for example, after an HF exposure. Inert gas can be introduced to the chamber, or an oxygen gettering chemical can be introduced with the superheated steam.

In some embodiments, the process can be repeated, e.g., a superheated liquid can be repeatedly supplied and drained from the chamber, for example, to clean the silicon to a desired cleanliness

Operation 620 repeatedly releases and stops releasing pressure in the first chamber. A cyclic nucleation process can be performed to clean the object, especially in hard to get areas. Since the chamber pressure is above atmospheric, a chamber valve can be open to release the chamber pressure, thus generating bubbles in the liquid for cleaning. The valve can be close, and the pressure can be built up to terminate the bubbles. The valve can be cyclically open and close, which can cyclically releasing and stop releasing pressure in the chamber.

Alternatively, a supply valve connected to a steam reservoir can be open to increase the pressure in the chamber. The pressure release can be performed by opening a relief valve, letting the steam escaping the chamber.

In some embodiments, a new superheated liquid can be provided to the chamber, after draining the existing superheated liquid. The cyclic nucleation process can be repeated. In some embodiments, a new superheated liquid can be provided to the chamber to bring the chamber to a high pressure before moving to the next step of draining the liquid while keeping the high pressure.

Operation 620 drains the superheated liquid to a second chamber, wherein the pressure of the second chamber is similar to that of the first chamber. After the superheated liquid is drained, the chamber can contain superheated steam. A rapid release of the superheated steam can carry liquid droplets on the object, thus can effectively dry the wafers. In some embodiments, the process can be repeated, e.g., a new superheated steam can be re-supplied to the chamber, and then re-released for further drying. The new superheated steam can be dry superheated steam.

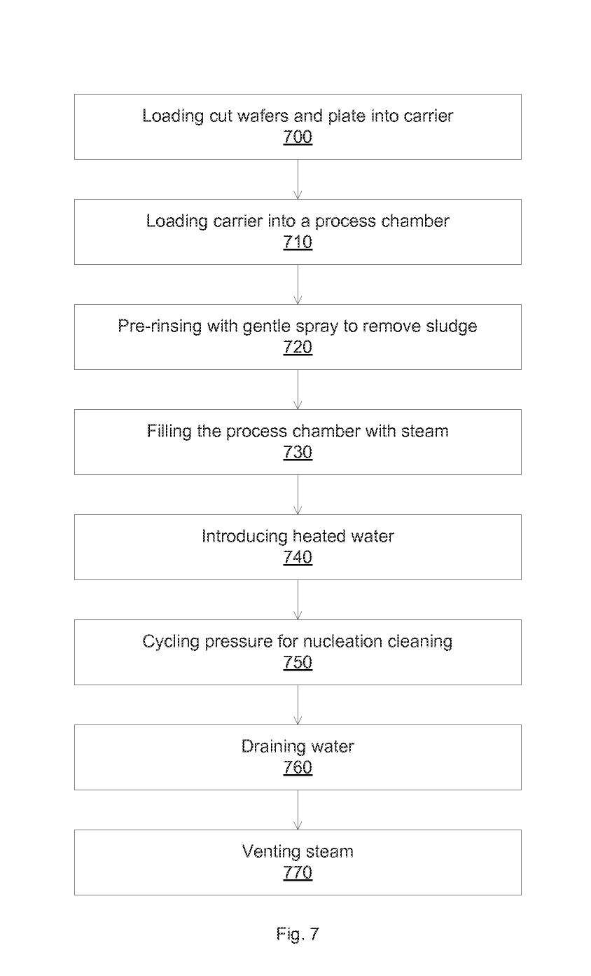

FIG. 7 illustrates an exemplary flow chart for a hyperbaric process for cleaning, rinsing and drying wafers according to some embodiments. Operation 700 loads cut wafers and plate into a carrier. Operation 710 loads a carrier into a process chamber. Operation 720 pre-rinses with gentle liquid spray to remove sludge. Operation 730 fills the process chamber with steam, preferably saturated or superheated steam. Operation 740 introducing heated water, such as saturated or superheated water. The water can comprise chemicals for cleaning or etching. Operation 750 cycles pressure for nucleation cleaning (CNX). Operation 760 drains the liquid. Operations 730-760 can be repeated with different or same liquid. Operation 770 vents the steam and dies the wafers in a drying process called Rapid Displacement Drying. The steam can be re-introduced and re-vent for further drying the wafer.

What is claimed is:

1. A method comprising
providing an object,
wherein the object comprises a holder component,
wherein the object comprises multiple parts bonded to the holder component;
supporting the multiple parts with a supporting component;
bringing the object to a first chamber;
cleaning the object with a superheated liquid in a repeated pressure cycling mode,
wherein the cleaning process releases the multiple parts from the holder component;
draining the superheated liquid;
drying the multiple parts with a superheated steam.

2. A method as in claim 1, wherein the temperature of the superheated liquid is between 100 and 200 C, wherein the pressure of the superheated liquid is between 1 bar and 16 bar.

3. A method as in claim 1, wherein the repeated pressure cycling mode comprises repeatedly reducing and stopping reducing the first chamber pressure.

4. A method as in claim 1, further comprising, before drying the multiple parts with a superheated steam,
supplying a new superheated liquid to the first chamber,
draining the new superheated liquid.

5. A method as in claim 4, further comprising
cleaning the object with the new superheated liquid in a repeated pressure cycling mode.

6. A method as in claim 1, wherein drying the multiple parts with a superheated steam comprises releasing the superheated steam to the atmospheric ambient.

7. A method for cleaning a post-wafer-saw block, wherein the post-wafer-saw block comprises a block saw into multiple plates after being bonded to a holder component so that each plate is attached to the holder component, the method comprising
supporting the multiple plates with a supporting component in a first chamber;
supplying a superheated liquid to the first chamber to at least partially submerge the multiple plates;
repeatedly
releasing pressure in the first chamber to an outside ambient,
stopping the pressure release;
draining the superheated liquid.

8. A method as in claim 7 further comprising
supplying a superheated steam to the first chamber before supplying the superheated liquid to the first chamber.

9. A method as in claim 8 further comprising
adding a chemical to the superheated steam,
wherein the chemical comprises HF or an oxygen-gettering chemical.

10. A method as in claim 7, further comprising
de-bonding the multiple parts from the holder component by the superheated liquid before releasing and stopping releasing pressure.

11. A method as in claim 7, wherein releasing pressure and stopping releasing pressure comprise opening and closing a valve, wherein the valve is coupled to a vapor portion of the first chamber.

12. A method as in claim 7, further comprising, after the object is cleaned with the superheated liquid in the repeated pressure cycling mode,
supplying a new superheated liquid to the first chamber,
draining the new superheated liquid.

13. A method as in claim 12, further comprising
repeatedly releasing pressure and stopping releasing pressure with the new superheated liquid.

14. A method as in claim 7, wherein the superheated liquid is drained to a second chamber, wherein the pressure of the second chamber is similar to that of the first chamber when draining

15. A method as in claim 7, further comprising
releasing a superheated steam in the first chamber to the atmospheric ambient,
wherein the superheated steam is from the superheated liquid after draining

16. A method as in claim 15, further comprising
repeating releasing the superheated steam to the atmospheric ambient and supplying a new superheated steam to the first chamber.

17. A system for cleaning a post-wafer-saw block, wherein the post-wafer-saw block comprises a block saw into multiple plates after being bonded to a holder component so that each plate is attached to the holder component, the system comprising
a sealable first chamber,
wherein the first chamber comprises a first inlet and a first outlet,
wherein the first inlet is configured to accept a superheated liquid,
wherein the outlet is configured to release a superheated liquid;
a support,
wherein the support is positioned in the first chamber;
wherein the support comprises multiple slots, wherein the slots are configured to support the plates at a side edge,
wherein the first inlet is positioned at a top of the support,
wherein the first outlet is positioned at a bottom of the support;
a sealable second chamber,
wherein the second chamber is coupled to the first chamber through a valve coupled to the first outlet,
wherein the second chamber is configured to receive superheated liquid from the first chamber when the valve is open,

18. A system as in claim 17
wherein first chamber further comprises a second outlet,
wherein the second outlet is position at a bottom of the support,
wherein the second outlet is configured to release a pressure from the first chamber,
wherein the conductance of the second outlet is larger than that of the first outlet.

19. A system as in claim 17
wherein first chamber further comprises a second inlet,
wherein the second inlet is position at a top of the support,
wherein the second inlet is configured to accept a superheated steam.

20. A system as in claim 17 further comprising
a reservoir, wherein the reservoir is configured to supply the superheated liquid to the first inlet, and wherein the reservoir is configured to supply the superheated steam to the second inlet.
